(19) United States
(12) Patent Application Publication
(10) Pub. No.: US 2018/0197147 A1
(43) Pub. Date: Jul. 12, 2018

(54) Method for Matching Employers and Candidates

(71) Applicant: Daniel Darren Cigelnik, Ottawa (CA)

(72) Inventor: Daniel Darren Cigelnik, Ottawa (CA)

(21) Appl. No.: 15/404,734

(22) Filed: Jan. 12, 2017

(51) Int. Cl. G06Q 10/10; G06F 17/30

(52) U.S. Cl. CPC G06Q 10/1053; G06F 17/30867; G06Q 10/109

(57) ABSTRACT

A method for matching employers and candidates comprising the steps of downloading, installing, and initiating an application on a candidate mobile device; creating a candidate profile; downloading, installing, and initiating the application on an employer mobile device; creating an employer profile; searching a database for an employer; sending a nudge to the employer; searching the database for the candidate profile; creating a job fair; sending an interview request; and scheduling an interview.

### BACKGROUND OF THE INVENTION

### 1. Field of the Invention

The present disclosure relates to the field of professional networking and, more specifically, the present disclosure relates to the field of an application loaded onto a mobile device that allows an employer to network with potential employees.

### 2. Description of Related Art

Professional networking is essential for employers to find qualified employees. Similarly, professional networking is essential for individuals to find jobs for which they are qualified. Current technologies require employers and candidates to use third party services that require creating profiles, posting to databases, and manually searching and filtering job postings. Such third party services include Monster, Indeed, or Craigslist. Further, current technologies have unlimited communication abilities between employer and candidates. For example, current technologies allow the candidate and the employer to send emails or call each other. This free flow of communication is problematic for several reasons. Firstly, it allows candidates to openly and freely communicate with the employer. This allows the candidate to constantly bombard the employer with communications thereby wasting the employer's time and energy. Secondly, the free flow of information allows ambiguous, misleading, or fraudulent communications to be sent and received by either the employer or the candidate.

Current technologies do not facilitate easy and simple interview scheduling. Currently, once an employer offers to interview the candidate, the parties are forced to exchange potential interview dates and times in a cumbersome way such as email, phone call, text, or SMS messaging. This type of cumbersome communication easily lends itself to ambiguous and confusing communications exchanged between the candidate and employer.

Current technology does not allow employers to create job fairs. Instead, employers are forced to engage third-party service providers to create and implement a job fair. Additionally, even when a job fair is created, there is little assurance that notice of the fair will reach ideal candidates because the candidates must also engage the same third-party service providers.

Based on the foregoing, there is a need in the art for mobile device-based application that allows a candidate to search nearby employers currently seeking employees, to request and set up interviews using a simple and easy method, that allows employers to easily and quickly set up notifications for job fairs that is registered by near-by candidates, and that limits the amount of communication between candidates and employers before both parties have confirmed interest in each other.

### SUMMARY OF THE INVENTION

The current invention discloses a method for matching employers and candidates comprising the steps of downloading, installing, and initiating an application on a candidate mobile device; creating a candidate profile; downloading, installing, and initiating the application on an employer mobile device; creating an employer profile; searching a database for an employer; sending a nudge to the employer; searching the database for the candidate profile; creating a job fair; sending an interview request; and scheduling an interview. The mobile device comprises an electronic device capable of communicating with other electronic devices though a wired or wireless connection including a cell phone, tablet, laptop computer, desktop computer, or a kiosk. The candidate profile comprises a candidate username, a candidate password, one or more candidate photos, one or more candidate videos, a candidate biography, a geographic region, and a desired position. The database comprises a cloud-based or remotely-located database, wherein the database further comprises the ability to receive, store and send information to the candidate mobile device and the employer mobile device. The nudge comprises an alert generated by the candidate and delivered to the employer. The amount of nudges the candidate can generate is limited. The employer mobile device comprises an electronic device capable of communicating with other electronic devices though a wired or wireless connection including a cell phone, tablet, laptop computer, desktop computer, or a kiosk. The employer profile comprises an employer username, an employer password, one or more employer photos, one or more employer videos, a geographic location, and an employer biography. The interview request comprises two time options provided by the employer from which the candidate can select. The application installed on the employer mobile device comprises a searchably selectable drop-down list of desired positions selected from the group consisting of: a barista, a bartender, a busboy, a chef, a cocktail server, a concession stand attendant, a dishwasher, a fast food attendant, a fine dining attendant, a line cook, a prep cook, a maitre d', a restaurant host, and a server.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a flow chart diagram of the method for matching employers and candidates, according to an embodiment of the present invention.

### DETAILED DESCRIPTION OF PREFERRED EMBODIMENTS

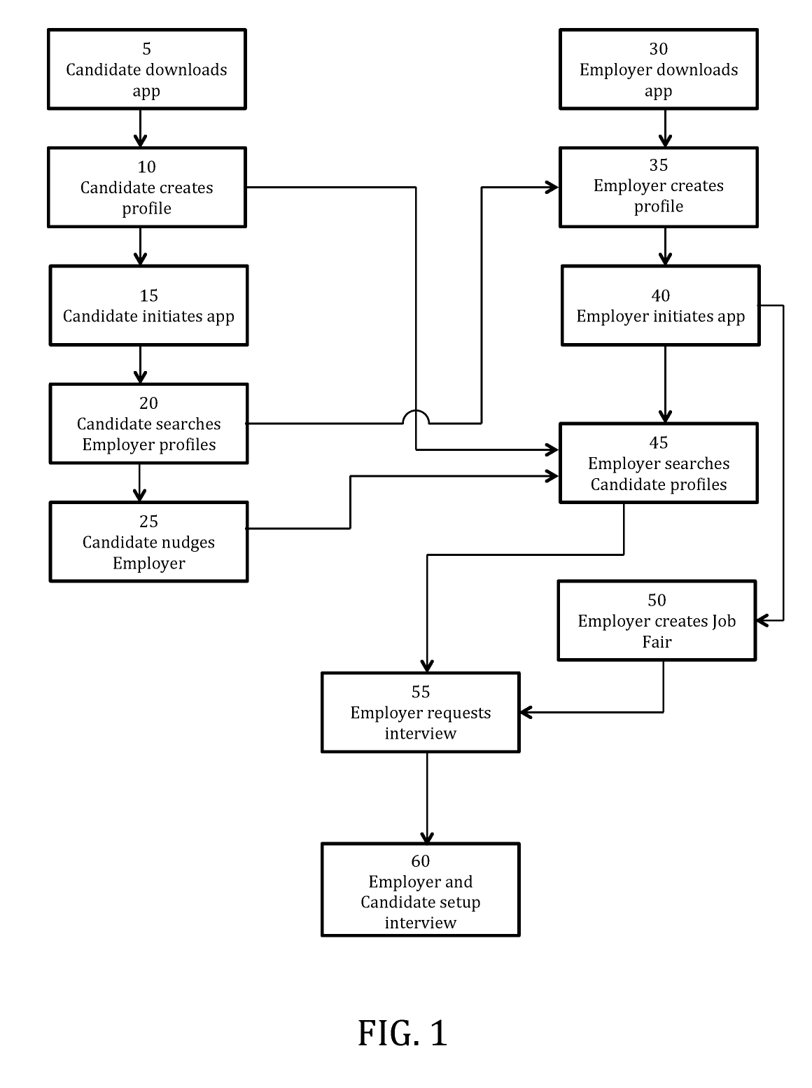

Preferred embodiments of the present invention and their advantages may be understood by referring to FIG. 1, wherein like reference numerals refer to like elements.

In an exemplary embodiment of the present disclosure, the system uses a mobile device and a program comprising one or more algorithms, routines, sub-routines, graphical user interfaces, or input-output interfaces, loaded thereon, known as an app. The mobile device comprises any electronic device capable of communicating with other electronic devices through a wired or wireless connection including a cell phone, tablet, laptop computer, desktop computer, a kiosk, or the like.

In another exemplary embodiment of the present disclosure, either a candidate or an employer uses the app. A candidate downloads and installs the app on the candidate's mobile device. The candidate creates an account comprising a username, a password, photos, videos, a personal biography, a professional biography, and other parameters including the type of position desired. In another embodiment of the present disclosure, the candidate uses a preexisting social media or professional account to create the candidate account including Facebook, Linkedln, Google Circles, Twitter, SnapChat, and Monster. The system allows the candidate to search employer profiles and send a notification to those employers in which the candidate is interested. In one embodiment, the notification comprises a nudge wherein the candidate sends a notification that is received by the employer alerting them that a candidate is interested in being employed by the employer. In another embodiment of the present disclosure, the system stores information related to the candidate profile on a database. In another embodiment of the present invention, the database comprises a cloud-based computing system.

In another exemplary embodiment of the present disclosure, an employer downloads the app and installs it on a mobile device. The employer creates a profile comprising a username, a password, photos of the business, the business name, the business address, the business email, the company's biography, and notes on the company. In another embodiment of the present invention, the employer uses a preexisting social media or professional account to create the candidate account including Facebook, LinkedIn, Google Circles, Twitter, SnapChat, or Monster. The employer's account is verified by the system sending the employer a code to confirm their account. The system allows the employer to search for desired candidates by providing one or more drop down menus allowing the employer to select desired parameters. In one embodiment of the present disclosure, the parameters include the position such as barista, bartender, busboy, chef, cocktail server, concession stand, dishwasher, line cook, prep cook, and server. In another embodiment of the present invention, the system stores information related to the employer profile on a database. In another embodiment of the present invention, the database comprises a cloud-based computing system.

In another exemplary embodiment of the present disclosure, the system allows the employer to create an interview wherein the system allows the employer to send a request for interview to one or more candidates. The interview request comprises one or more date and times of which the candidate can select. In one embodiment, the candidate has a limited time to accept the interview, including a 24-hour limit. Once a candidate selects one of the employer's date and times, the system sends an interview confirmation to the candidate and the employer. In another embodiment of the present disclosure, the employer can select two possible date and times from which the candidate can choose. In another embodiment of the present disclosure, the employer can select an unlimited number of possible date and times to interview from which the candidate can choose one or more. In another embodiment, the employer can select ranges of dates and times from which the candidate can specify. In another embodiment, the interview date and time is graphically displayed on the candidate's app and the employer's app. In another embodiment, the system notifies the candidate of a pending interview using an audible sound.

In another exemplary embodiment of the present disclosure, the system returns a list of desired candidates according to the employer's search parameters. In one embodiment, the parameters include type of employment, the position to be filled, full- or part-time employment, and ranges of compensation. In one embodiment, the employer may search for parameters comprising The employer may view the candidate's profile including the candidate's pictures, videos, professional biography, personal biography, and desired job. The system allows the employer to select desired candidates. In one embodiment of the present invention, the employer selects the desired candidate by tapping a prompt on the app. In one embodiment, the calendar view comprises color-coordinated graphical representations for interviews including confirmed interviews in red and pending interviews in yellow. In another embodiment, the graphical representations include the candidate's name and experience as well as an option to cancel the interview.

In another exemplary embodiment of the present disclosure, the system allows the employer to create a job fair wherein the employer selects ideal parameters and characteristics for candidates. The system sends a notification to all candidates that match the employer's desired parameters. In another embodiment, the system's job fair notification is limited to a specific geographic area predetermined by the employer or, if not selected by the employer, supplied by the system.

In another exemplary embodiment of the present disclosure, the system provides an employer dashboard to the employer. The employer dashboard comprises a calendar, a menu and the ability to edit the employer's profile. The calendar comprises a daily view, a weekly view, a monthly view, and a yearly view. In another embodiment of the present disclosure, the system provides a candidate dashboard to the candidate. The candidate dashboard comprises a calendar, a menu, and the ability to edit the candidate's profile. The calendar comprises a daily view, a weekly view, a monthly view, and a yearly view.

In another exemplary embodiment of the present disclosure, the system comprises nudges wherein the employer or candidate is notified. The nudges comprise a notification system wherein the candidate sends a notification to an employer with whom the candidate desires employment. In one embodiment, the candidate is limited to a fix number of nudges. In on embodiment, the candidate can purchase additional nudges from the system. In another embodiment of the present disclosure, the system does not allow any contact between the employer and candidate. In another embodiment, the system only allows the employer to contact the candidate through nudges or interview requests. In another embodiment, the system allows text messages between the employer and candidate. In another embodiment, the system only allows communication from the employer to the candidate.

In another embodiment of the present disclosure, the system allows the employer to rate the quality of the interview. In one embodiment, the system sends the rating notification to the employer's mobile device wherein the employer is able to rate the interview using user-defined system-defined parameters. In another embodiment, the system terminates candidate profiles that garner a pre-set number of negative interview reviews.

In another exemplary embodiment of the present disclosure and with reference to FIG. 1, in step 5, the system comprises a database, a candidate mobile device and a program on the candidate mobile device, known as an app. The candidate downloads the app from a cloud-based server and installs it onto the candidate mobile device. In another embodiment, the system provides a content form to the candidate when the app loaded for the first time and does not provide the content form each time the app is loaded thereafter.

In another exemplary embodiment of the present disclosure and with reference to FIG. 1, in step 10, the candidate creates a candidate profile using the app. The app determines that the candidate is seeking employment by using a drop-down, user-selectable menu. The candidate profile contains searchable fields of information that an employer can use to search available candidates. In another embodiment, the candidate profile comprises a video, an embedded video, pictures, selectable drop-down menus for previous work experience, a selectable drop-down menu indicating whether the candidate is seeking full-time or part-time work, a biography of the candidate, and candidate-fillable notes. In another embodiment, the candidate profile is stored on the database. In one embodiment, the candidate profile is stored on a cloud-based computing system. In another embodiment, the candidate profile is autonomously populated from the candidate's social media account comprising LinkedIn, Facebook, Google Circles, and Instagram. In another embodiment, the candidate manually creates the candidate profile that the app verifies against the candidate's social media profile.

In another exemplary embodiment of the present disclosure and with reference to FIG. 1, in step 15, the candidate initiates the app. In another embodiment, the app autonomously initiates when the system delivers a notification to the candidate. In another embodiment, the candidate utilizes a username and password to initiate the app and access the information and services.

In another exemplary embodiment of the present disclosure and with reference to FIG. 1, in step 20, the system provides a candidate search module wherein the candidate searches employer profiles for desirable employment. In one embodiment, the candidate searches for desired employment using a keyword search. In another embodiment, the candidate searches for desired employment using drop-down and candidate-selectable options provided by the system.

In another exemplary embodiment of the present disclosure and with reference to FIG. 1, in step 25, the candidate uses a nudge to notify the employer that the candidate desires employment with the employer. In another embodiment, the candidate notifies the employer using a nudge wherein the candidate sends and the employer receives a notification. In another embodiment, the candidate is limited to a fixed number of nudges the candidate can send to the employer. In another embodiment, the candidate can obtain additional nudges from the system by purchasing nudges from the system.

In another exemplary embodiment of the present disclosure and with reference to FIG. 1, in step 30, the employer downloads the app and installs it on the employer's mobile device. In another embodiment, the system provides a content form to the employer when the app loaded for the first time and does not provide the content form each time the app is loaded thereafter.

In another exemplary embodiment of the present disclosure and with reference to FIG. 1, in step 35, the employer creates an employer profile comprising photos, a business name, a business address, a phone number, an email address, a biography, and employer-fillable notes. In another embodiment, the system confirms the employer account by sending an email to the address listed by the employer. In another embodiment, the system stores the employer profile on the database.

In another exemplary embodiment of the present disclosure and with reference to FIG. 1, in step 40, the employer initiates the app. In one embodiment, the system provides an employer dashboard to the employer though the app comprising an employer search module, an employer menu, an employer calendar, a job fair module, and an employer nudge module.

In another exemplary embodiment of the present disclosure and with reference to FIG. 1, in step 45, the employer searches for desired candidates by using the employer search module. The employer search module comprises one or more drop-down menus that allow the employer to search by candidate characteristics. In another embodiment, the employer can search by type of position available comprising barista, bartender, busboy, chef, cocktail server, concession stand, dishwasher, fast food, fine dining, line cook, prep cook, maitre d', a restaurant host, and server. In another embodiment, the employer nudge module notifies the employer of the nudges received from the candidate. In another embodiment, the system displays the candidate profile to the employer. In another embodiment, the system presents the candidate profile only if it matches the employer's search parameters or if the candidate sent a nudge to the employer. In another embodiment, the employer can select candidate profiles by using a swiping motion wherein the employer swipes right to select the candidate profile for further viewing and swipes left to skip the candidate profile. In another embodiment, the employer selects the candidate by tapping a button on the app's graphical interface.

In another exemplary embodiment of the present disclosure and with reference to FIG. 1, in step 50, the employer creates a job fair wherein the employer sets particular desired parameters potential employees. In one embodiment, the particular desired parameters include type of employment, the position to be filled, full- or part-time employment, and ranges of compensation. The system notifies the candidate if the candidate matches the desired parameters. In another embodiment, the candidate is notified if the candidate is located within a specified geographic distance from the employer address.

In another exemplary embodiment of the present disclosure and with reference to FIG. 1, in step 55, the employer requests an interview from the candidate. In one embodiment, the system allows the employer to send an invitation to interview by tapping a single button on the app's graphical user interface. When initiated by the employer, the system delivers a notification to the candidate's mobile device stating that the employer desires an interview with the candidate. The system prompts the employer to select two date and time options to interview the candidate. The system allows the candidate to review the request for interview and the employer's profile. The candidate has the option to select a date and time option provided by the employer. If the candidate does not desire to interview with the employer or is unavailable during the specified date and times, the system allows the candidate to refuse the interview request. In another embodiment, the system cancels the interview request if the candidate does not respond within a specified period of time. In another embodiment, the employer is notified of candidate's refusal and has the option to send additional date and times to interview. In another embodiment, the app on the employee mobile device autonomously checks that the candidate is available at the times selected for the interview request.

In another exemplary embodiment of the present disclosure and with reference to FIG. 1, in step 60, the system alerts the employer and candidate that an interview has been offered by an employer and accepted by a candidate. The system lists the interview date and time on the employer calendar and the candidate calendar. Once the interview is complete, the employer can remove it from the employer calendar. In one embodiment, the system autonomously removes the interview from the candidate profile when it is removed from the employer calendar. In another embodiment of the present disclosure, the system allows the employer to rate the interview. In another embodiment, the system prevents candidates from using the system if that candidate garners a specified number of negative reviews.

In another embodiment, the app allows the employer and the candidate to conduct the interview using a built-in teleconferencing interface wherein the app provides visual cues based on the candidate's facial expressions. In another embodiment, the app autonomously records the entire interview and allows the candidate and the employer to replay and replay the entire interview.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A method for matching employers and candidates comprising the steps of:
a. downloading, installing, and initiating an application on a candidate mobile device;
b. creating a candidate profile;
c. downloading, installing, and initiating the application on an employer mobile device;
d. creating an employer profile;
e. searching a database for an employer;
f. sending a nudge to the employer;
g. searching the database for the candidate profile;
h. creating a job fair comprising
i. a job fair alert comprising the employer profile and a vacant position;
ii. wherein the job fair alert is sent by the application installed on the employer mobile device and received by the application installed on the candidate mobile device if the candidate profile meets one or more matching criteria.
i. sending an interview request; and
j. scheduling an interview.

2. The method of claim 1 wherein the candidate mobile device comprises an electronic device capable of communicating with other electronic devices though a wired or wireless connection including a cell phone, tablet, laptop computer, desktop computer, or a kiosk.

3. The method of claim 1 wherein the candidate profile comprises a candidate username, a candidate password, one or more candidate photos, one or more candidate videos, a candidate biography, a geographic region, and a desired position.

4. The method of claim 1 wherein the database comprises a cloud-based or remotely-located database, wherein the database further comprises the ability to receive, store and send information to the candidate mobile device and the employer mobile device.

5. The method of claim 1 wherein the nudge comprises an alert generated by the candidate and delivered to the employer.

6. The method of claim 1 wherein the amount of nudges the candidate can generate is limited.

7. The method of claim 1 wherein the employer mobile device comprises an electronic device capable of communicating with other electronic devices though a wired or wireless connection including a cell phone, tablet, laptop computer, desktop computer, or a kiosk.

8. The method of claim 1 wherein the employer profile comprises an employer username, an employer password, one or more employer photos, one or more employer videos, a geographic location, and an employer biography.

9. The method of claim 1 wherein the interview request comprises two time options provided by the employer from which the candidate can select.

10. The method of claim 1 wherein the application installed on the employer mobile device comprises a searchable selectable drop-down list of desired positions selected from the group comprising: a barista, a bartender, a busboy, a chef, a cocktail server, a concession stand attendant, a dishwasher, a fast food attendant, a fine dining attendant, a line cook, a prep cook, a maitre d', a restaurant host, and a server.
